(19) United States
(12) Patent Application Publication
(10) Pub. No.: US 2007/0089583 A1
(43) Pub. Date: Apr. 26, 2007

(54) Blind cutting aid

(76) Inventor: Li-Ming Cheng, Kaohsiung City (TW)

Correspondence Address: BIRCH STEWART KOLASCH & BIRCH, PO BOX 747, FALLS CHURCH, VA, 22040-0747, US

(21) Appl. No.: 11/410,989

(22) Filed: Apr. 26, 2006

(30) Foreign Application Priority Data
Oct. 26, 2005 (CN) 200520045904.2

(51) Int. Cl. B26D 7/02; B26D 7/00

(52) U.S. Cl. 83/455; 83/761

(57) ABSTRACT

A blind cutting aid has a hollow body consisting of a front wall, a rear wall, a top wall and a bottom wall. It also has a cutting slot on one side vertical to the bottom wall and running through the top wall, front wall and rear wall and close to the bottom wall. A blind can be rolled and encased in the blind cutting aid. The cutting slot can direct a cutting tool to do cutting and form a vertical and neat lateral side on the blind. Thus the entire profile of the blind is more appealing. It also can position and anchor the rolled blind to make cutting operation smoother and quicker.

### FIELD OF THE INVENTION

The present invention relates to a blind cutting aid and particularly to a cutting aid to direct a cutting tool vertically downwards during cutting a blind.

### BACKGROUND OF THE INVENTION

A great number of window coverings now on the market such as Venetian blinds, shutters and the like are installed by users after purchase. During installation on the doors or windows, if the width of the window covering is greater than that of the doors or windows, the window covering has to be cut to a desired width. FIG. 1 shows a blind which serves as an example. The blind 1 has an upper track 11, a lower track 12, a slat assembly 13 located between them, and a lift cord control means 14 to lift the slat assembly 1 upwards or extend the slat assembly 1 downwards. During installation of the blind 1, if the width of the upper and lower tracks 11 and 12, and slat assembly 13 is greater than the width of a door or window, the slat assembly 13 has to be rolled as shown in FIG. 2. Then the length (α) of the extra portion is cut off by means of a cutting tool such as a saw to make the total width of the blind 1 to fit the width of the door or window. The cutting process mentioned above still has problems in practice, notably:

1. As the general blind is quite bulky, during cutting the extra portion from top to bottom, it is difficult for users to measure the accurate vertical angle. Without a proper cutting aid the lateral side of the blind 1 being cut tends to skew. The whole profile of the blind 1 is not appealing.

2. Although the slat assembly 13 may be rolled for cutting, during the cutting process users have to grasp the cutting tool with one hand and hold the blind 1 with other hand to prevent the rolled slat assembly 13 from scattering. This makes cutting operation more difficult.

### SUMMARY OF THE INVENTION

Therefore the primary object of the present invention is to provide a blind cutting aid to direct a cutting tool to perform cutting process when altering the width of a blind is required. The lateral side of the blind after cutting is vertical and neat.

To achieve the foregoing object, the blind cutting aid of the invention includes a hollow body consisting of a front wall, a rear wall, a top wall and a bottom wall. The hollow body has a housing chamber inside running through two ends thereof. The housing chamber forms a first holding portion with the top wall, and a second holding portion with the bottom wall. The blind cutting aid also has a cutting slot on one side vertical to the bottom wall and running through the top wall, front wall and rear wall close to the bottom wall.

The structure set forth above can achieve the following effects:

1. The cut blind is neat without skewing. The cutting slot can direct the cutting tool without forming a skewed lateral side on the blind. The resulting blind is neat and more appealing, and desirable for house decoration.

2. Cutting operation is more convenient. The blind is rolled and held in the blind cutting aid, and can be positioned and anchored securely. Hence cutting is easier.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of a conventional blind

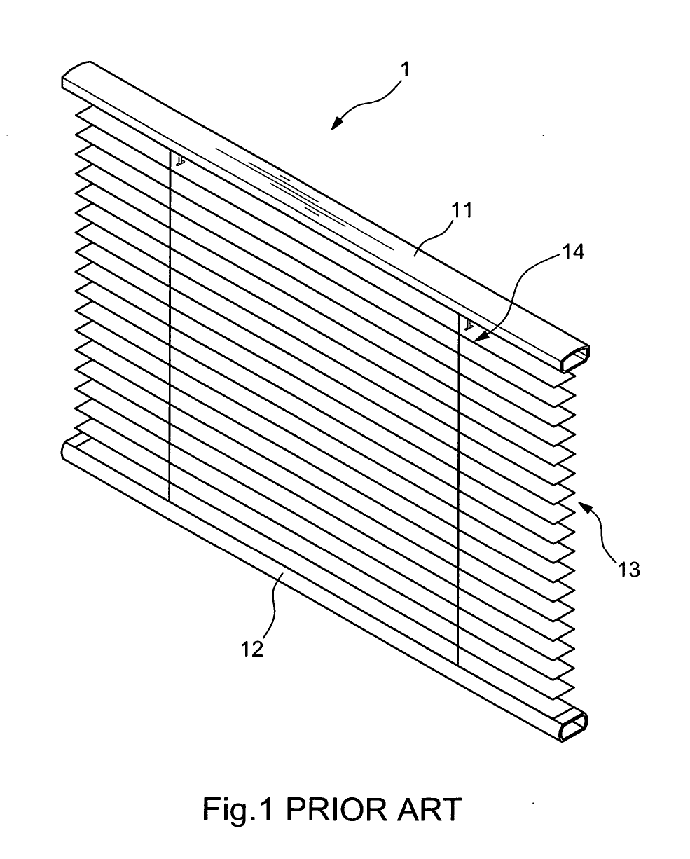

FIG. 2 is a front view of a conventional blind after cutting.

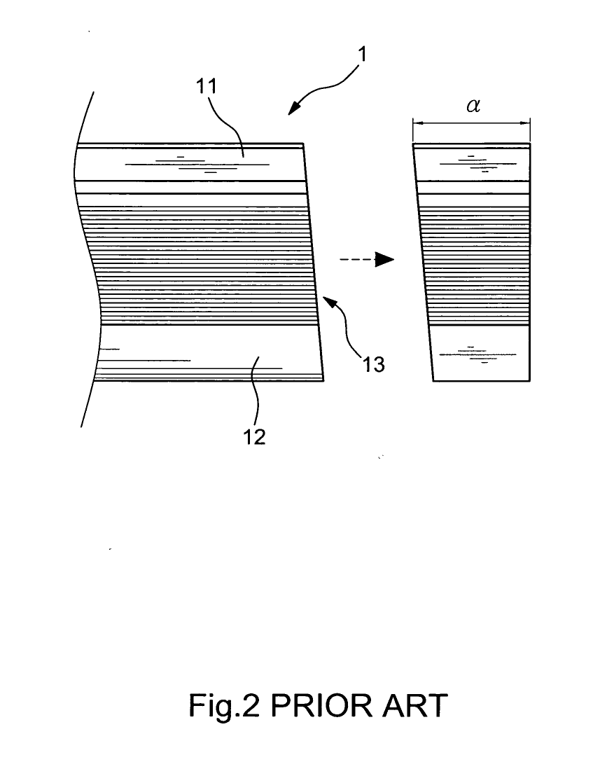

FIG. 3 is a perspective view of the present invention.

FIG. 4 is a schematic view of the present invention in operating condition-1.

FIG. 5 is a schematic view of the present invention in operating condition-2.

FIG. 6 is a schematic view of the present invention in operating condition-3.

FIG. 7 is a schematic view of the present invention in operating condition-4.

FIG. 8 is a schematic view of the present invention in operating condition-5.

### DETAILED DESCRIPTION OF THE PREFERRED EMBODIMENT

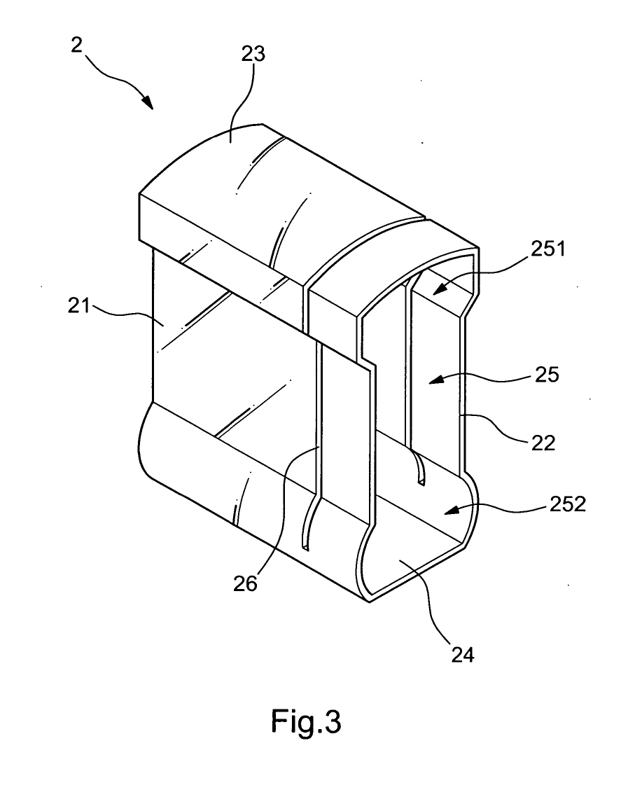

Please refer to FIG. 3, the blind cutting aid 2 according to the invention is a hollow body consisting of a front wall 21, a rear wall 22, a top wall 23 and a bottom wall 24. The hollow body has a housing chamber 25 inside running through two ends thereof. The housing chamber 25 forms a first holding portion 251 with the top wall 23 to be run through by an upper track of a blind, and a second holding portion 252 with the bottom wall 24 to be run through by a lower track of the blind. The blind cutting aid 2 further has a cutting slot 26 on one side vertical to the bottom wall 24 that runs through the top wall 23, front wall 21 and rear wall 22 close to the bottom wall 24.

The hollow body is formed integrally by the front wall 21, rear wall 22, top wall 23 and bottom wall 24 and transparent. Hence during cutting operation users can see through the blind cutting aid 2 and control the dimension of the portion of the blind to be cut.

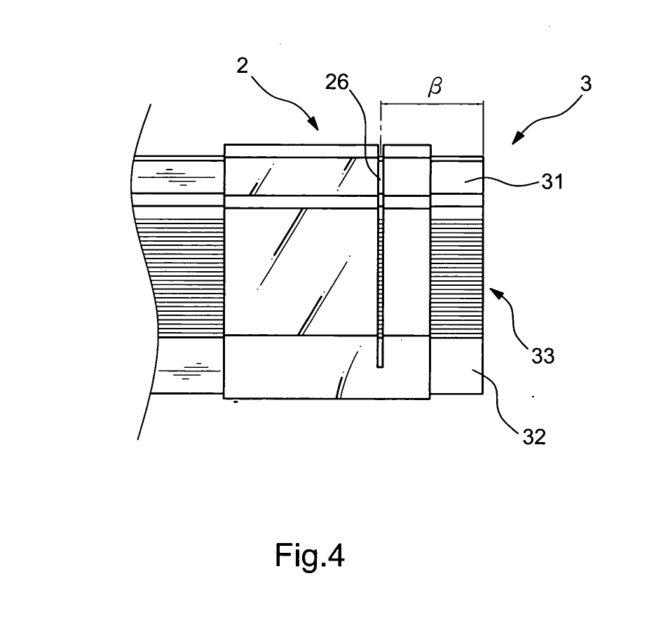

Refer to FIG. 4, the blind cutting aid 2 of the invention aims to aid cutting a blind 3 which has an upper track 31, a lower track 32 and a slat assembly 33, such as a Venetian blind, shutter and the like. Details of use conditions are discussed below:

Referring to FIGS. 3 and 4, first, the slat assembly 33 of the blind 3 to be cut is rolled; the slat assembly 3 is encased in the blind cutting aid 2 with the rolled slat assembly 33 held in the housing chamber 25, the upper track 31 running through the first holding portion 251 and the lower track 32 running through the second holding portion 252; measure the length (β) on one side of the blind 3 to be cut off; align the cutting slot 26 at the measured length (β); as the blind cutting aid 2 is transparent, measuring and alignment can be done easily.

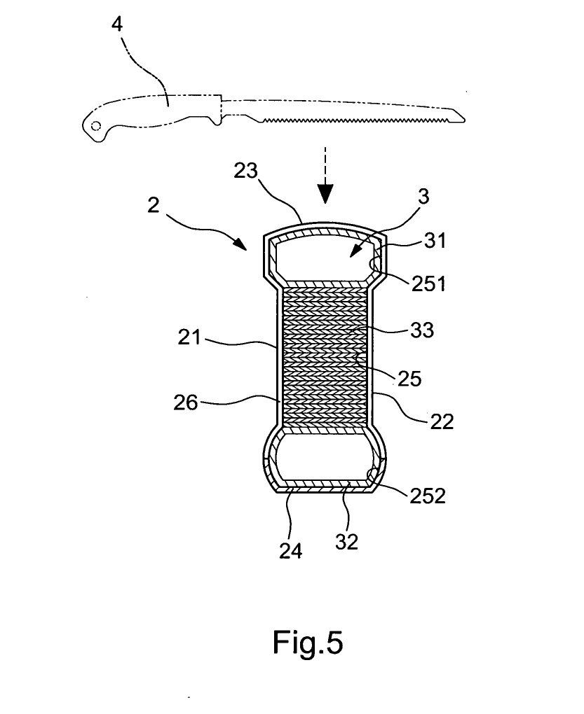

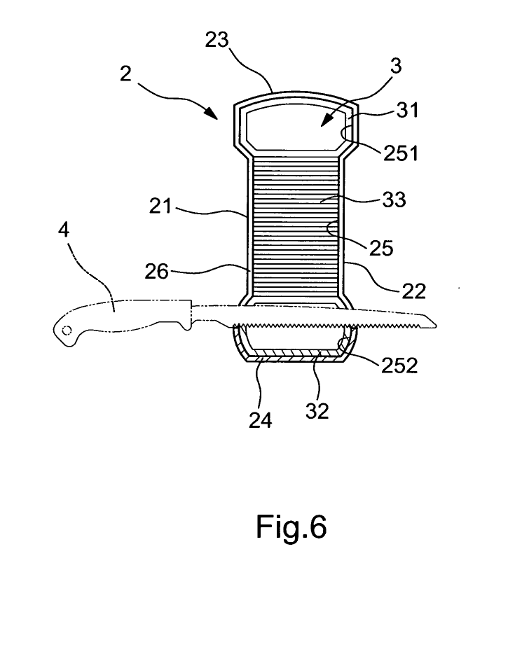

Referring to FIGS. 5 and 6, place a cutting tool 4 such as a saw or the like into the cutting slot 26 with one hand holding the top wall 23 and other hand grasping the cutting tool 4; slit the upper track 31, slat assembly 33 and the lower track 32 in this order until reaching the end of the cutting slot 26.

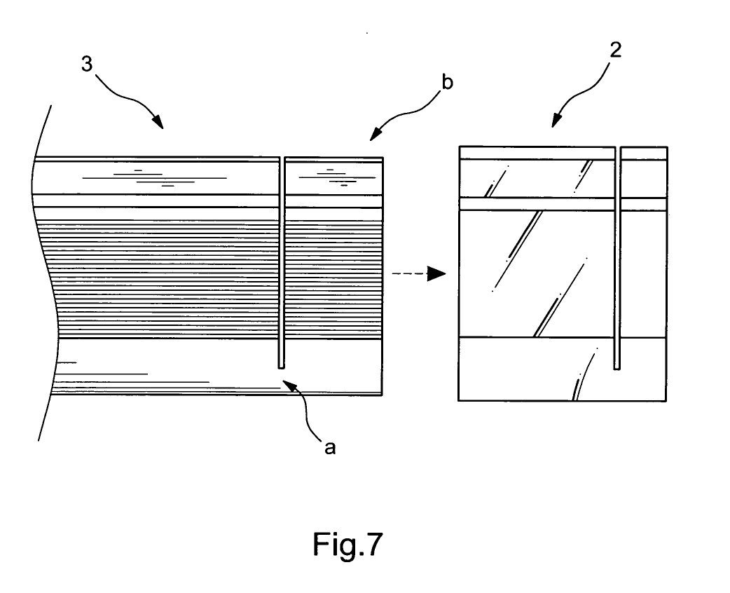

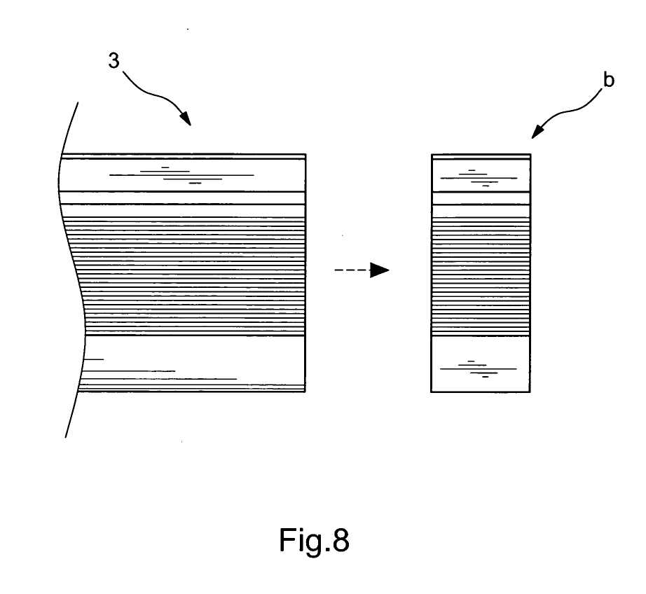

Referring to FIGS. 7 and 8, remove the blind cutting aid 2 from the blind 3; slit the remained portion (a) through the cutting tool 4 until the extra portion (b) is cut off. Then the cut blind 3 can be installed on a door or window desired with a mating width.

The blind cutting aid 2 thus formed has the following features:

1. The blind 3 to be cut is encased in the blind cutting aid 2. When the cutting tool 4 is placed in the cutting slot 26 to do cutting, due to the cutting slot 26 is vertical to the bottom wall 24, it provides a desired directing effect for moving the cutting tool 4 downwards. Hence the lateral side of the blind 3 being cut is neat without skewing. The entire blind 3 is more appealing.

2. The blind cutting aid 2 surrounds the blind 3 and provides a desired positioning and anchoring effect. During cutting process, the rolled slat assembly 33 does not scatter or extend. Thus cutting can be done more smoothly and quickly.

In short, the blind cutting aid 2 of the invention makes cutting of the blind 3 more convenient. The lateral side of the cut blind 3 also can be maintained vertical and in a neater manner.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A blind cutting aid comprising a hollow body which includes a front wall, a rear wall, a top wall and a bottom wall and a housing chamber inside running through two ends thereof, the housing chamber and the top wall forming a first holding portion, the housing chamber and the bottom wall forming a second holding portion, the cutting aid having a cutting slot on one side vertical to the bottom wall, the cutting slot running through the top wall, the front wall and the rear wall and close to the bottom wall.

2. The blind cutting aid of claim 1, wherein the hollow body formed by the front wall, the rear wall, the top wall and the bottom wall is integrally formed and transparent.
